(19) United States
(12) Patent Application Publication
(10) Pub. No.: US 2006/0210029 A1
(43) Pub. Date: Sep. 21, 2006

(54) System and methods for handling voice mail messages to increase voice traffic in a telephone system

(75) Inventor: Shmuel Okon, Herzeliyya, IL (US)

Correspondence Address: Timothy W. Fitzwilliam, Esq., Suite 370, 351 Old Newport Blvd., Newport Beach, CA, 92663, US

(73) Assignee: ON-Q Telcom Systems Co., Inc.

(21) Appl. No.: 11/375,929

(22) Filed: Mar. 15, 2006

Related U.S. Application Data
(60) Provisional application No. 60/594,156, filed on Mar. 15, 2005.
(60) Provisional application No. 60/594,801, filed on May 8, 2005.

(51) Int. Cl. H04M 11/00

(52) U.S. Cl. 379/88.18

(57) ABSTRACT

A method for accessing a previously stored message left by a call originator at a destination subscriber's “Voice Mail” box. The method comprises the steps of: calling an unavailable destination, determining if a previously stored message left by the same call originator exists, notifying the call originator if an old message exists, and upon his request allowing him to access the old message and manipulate it. Additionally disclosed are a system and methods for handling messages left by a call originator at the destination subscriber's voice mail box. A preferred method comprises the steps of: calling an unavailable subscriber who has voice mail; recording and leaving a message in the voice mail box of the intended destination subscriber; after recording the message, caller decides weather to request notification when the message is heard by the recipient destination subscriber; the message is played by recipient, recipient decides whether to record a reply message for the caller; in case such a reply message has been recorded, the call originator is notified; in the case that the recipient decides not to record a reply message and there is a notification request by the caller as to when his message is heard, the recipient can chose to consent to or refuse such notification; in case the call originator receives notification that a reply message has been recorded in the destination subscriber's voice mail, he may enter the destination subscriber's voice mail box and play it, and if required, record a new message without the need of redialing.

This patent application contains subject matter claiming benefit of the priority date of U.S. Provisional Patent Applications Ser. No. 60/594,156 filed on Mar. 15, 2005 and entitled MEHTOD AND SYSTEM FOR ENABLING A CALLER TO ACCESS A PREVOUSLY STORED MESSAGE ON A DESTINATION VOICE MAIL SYSTEM, in addition to Ser. No. 60/594,801 filed on May 8,2005, entitled SYSTEM AND METHODS FOR HANDELING MESSAGES IN A VOICE MAIL SYSTEM TO INCREASE VOICE TRAFFIC IN A TELEPHONE SYSTEM, pursuant to 35 USC §119, the entire contents of these provisional patent applications are hereby expressly incorporated by reference.

### BACKGROUND OF THE INVENTION

1. Field of the Invention

The present invention pertains generally to telecommunication systems. More particularly, the present invention pertains to systems and methods that facilitate call completion and increase efficiency of voice communication. The present invention, in a preferred embodiment, is particularly, but not exclusively, useful as a method and system for manipulating messages in a voice mail system.

2. Description of the Prior Art

Voice communications systems such as those employing traditional wire networks or cellular networks are well known. Many existing systems contain inefficiencies in the event a call recipient is unavailable for contemporaneous communication. Hence, numerous attempts for carrying out calls from phone to phone, in general, and to cellular phones in particular, end without “Call Completion.” These missed calls can cause substantial losses to Telephone Service Companies that bill subscribers based on completed calls. One of the existing solutions for the reduction of lost calls is a message answering system or “voice mail.” Although voice mail is seemingly the ultimate solution to the problem, voice mail actually captures a very small number of the missed calls, and the rest of the missed calls turn into lost calls. Many studies have shown that when a person expecting human response on the other side of the line then suddenly encounters a machine, the person feels uncomfortable, and therefore one's impulsive response is incongruent with a judicious response. Telephone Service Companies supplying voice mail systems persevere on solutions that would decrease this apprehension, and enable a caller confronting the voice mail to act judiciously. The technological solution implemented by the companies gives the caller attempting to record a message an option to change the message to one's liking during or immediately after recording it. This solution indeed assists in overcoming the initial hesitation of confronting the voice mail, but does not provide the caller recording a message with any control after disconnecting from the voice mail service. An improvement is proposed by a U.S. Patent Application entitled, Modification of Delivered Voice Messages by the Originator, by Thomas C. Davis et. al., however Davis requires the message originator to record a message identifier tag to be used if the message is to be later modified. This solution however, would not further to reduce originator apprehension and provides an opportunity for user error.

As formerly stated, studies demonstrate that in the majority of cases individuals choose not leave voice mail messages. A primary reason is that in many cases the expectation of response following the recording of a voice mail message ends with no result, and the recorder of the message has no idea whether his/her message has been heard. On the other hand, the receiver of the message does not return a substantial amount of the messages since the motivation for making the call which resulted in the recording of the voice mail message was that of the caller, and from the standpoint of the voice mail box owner, returning the call does not justify the effort involved. Telecommunication companies supplying voice mail systems persevere on solutions that would facilitate the process of returning the call in the eyes of the voice mail box owner, and thus increase the number of completed calls resulting from callers making a choice to leave a voice mail message, thereby encouraging subsequent recording of messages. The technological solution implemented by these companies enables the voice mail box owner to dial the caller's number with a push of a single button. This solution does somewhat simplify the process, yet leaves the remainder of the problems unresolved.

In light of the above, it is an object of the present invention to provide a voice mail system and method that increases call completion so that originator calls that are missed do not result in lost calls. It is further an object of the present invention to provide an improved voice mail system and method for modifying existing voice messages at a later time. It is yet a further object of the present invention to provide a voice mail system and method that increases the motivation of the originator to leave the message and facilitates the voice mail box owner in handling and responding to the message.

### BRIEF SUMMARY OF THE INVENTION

The present invention specifically addresses and alleviates the above mentioned deficiencies associated with the prior art. More particularly, the present invention comprises a method for enabling a caller to access a previously stored message on a destination voice mail box, the method comprising: initiating a telephonic call to a recipient having the destination voice mail box, the call initiated by a originator wherein the recipient is unavailable to answer the call; transferring the call to a voice mail box; determining the telephone number of the originator; determining if the voice mail box contains a previously recorded message from the originator based on the telephone number; notifying the originator if the voice mail box contains the previously recorded message; and providing options to the originator to modify the previously recorded message.

The method of enabling a caller to access a previously stored message additionally comprises operating the voice mail system in an ordinary fashion if the voice mail box determines that a previously recorded message does not exist based on the telephone number. Further, the options to the originator to modify the previously recorded message comprise deleting the message and re-recording the message. Alternatively, the determining the telephone number of the originator is accomplished by caller line identification (CLI) method.

In another aspect, the present invention is a method to increase voice traffic on a in a telephone system, the method comprising: initiating a telephonic call to a recipient having the destination voice mail box, the call initiated by an originator wherein the recipient is unavailable to answer the call; transferring the call to a voice mail box and providing an option to leave a recorded message; determining the telephone number of the originator; providing the originator an option to be notified by the voice mail box when the recorded message has been accessed by the recipient; notifying the recipient as to the existence of the recorded message; and providing the recipient an option to record a reply message to the recorded message. The notifying the recipient as to the existence of the recorded message may be accomplished by Multimedia Messaging Service (MMS), Short Message Service (SMS), or other means. The method further comprises notifying the originator in the event that the recipient has recorded a reply message.

The method of increasing voice traffic in a telephone system further comprises, notifying the recipient in the event that originator requested to be notified when the recorded message had been heard by the recipient; requesting consent from the recipient to notify the originator that the recorded message had been heard by the recipient; and notifying the originator in the event that the recipient consented to notification. The method further comprises allowing the recipient the option to select from a plurality of previously prepared messages. The method yet further comprises allowing the originator to call the voice mail box of the recipient to listen to the reply message; providing an option for the originator to record a new reply message; and providing an option that the voice mail box attempt to connect the originator to the recipient.

In another aspect, the invention is a system for increasing voice traffic in a telephone system comprising: a telephonic call originator; a telephonic call recipient; a recipient voice mail box; a means for identifying a telephone number for the call recipient; a recorded message supplied by the originator; an announcement from the voice mail box to the originator that a conformation is available if desired by the originator; an announcement from the voice mail box to the recipient that the recorded message exists; an announcement from the voice mail box to the originator that the messages has been listened to by the recipient if the confirmation is desired and if the confirmation is consented to by the recipient; and a reply message from the recipient to the originator stored in the recipient voice mail box.

Further, the system comprises an announcement from the voice mail box to the originator that the reply message exists in the voice mail box. Additionally, the system further comprises a new recorded message from the originator to the voice mail box if the originator elects to record the new message upon receiving the announcement the reply message exists in the voice mail box. Yet still the system comprises a renewed telephonic call transmission from the originator to the recipient via the voice mail box in the event that the originator elects to do so upon hearing the reply message.

These, as well as other advantages of the present invention, will be more apparent from the following description and drawings. It is understood that changes in the specific structure shown and described may be made within the scope of the claims, without departing from the spirit of the invention.

While the apparatus and method has or will be described for the sake of grammatical fluidity with functional explanations, it is to be expressly understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112 are to be accorded full statutory equivalents under 35 USC 112. The invention can be better visualized by turning now to the following drawings wherein like elements are referenced by like numerals.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a flow chart illustrating a preferred method of enabling a caller to access a previously stored message on a destination voice mail system of the present invention.

FIG. 2a is a flow chart of a preferred method to increase traffic in a voice mail system (Part 1) illustrating steps for recording a message.

FIG. 2b is a flow chart of a the preferred method to increase traffic in a voice mail system (Part 2) illustrating steps for responding to the recorded message.

FIG. 2c is a flow chart of a the preferred method to increase traffic in a voice mail system (Part 3) illustrating steps for responding to a reply notification.

### DETAILED DESCRIPTION OF THE PREFERRED EMBODIMENTS

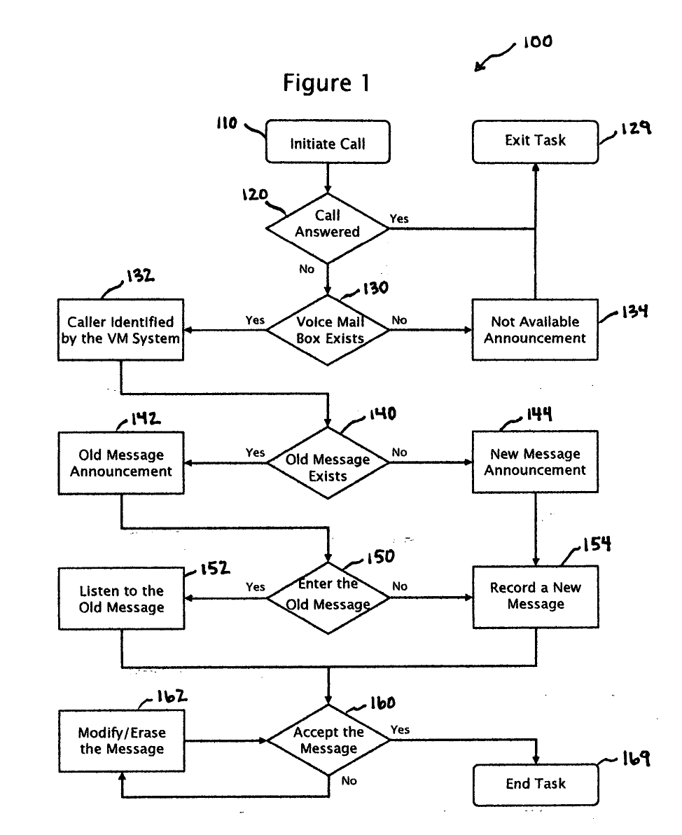

Referring initially to FIG. 1, a preferred embodiment of the present invention, generally designated 100, illustrates a flowchart of one method of implementing a task 100 which allows a caller to access his old message on a destination “Voice Mail” (VM) box, and manipulate it. This method is an add-on functionality to already existing and well known voice mail systems.

Initially, after a call is initiated (110) by an originator, a determination is made whether the destination is reachable (120). In other words, the task 100 tries to connect the call according to normal operating procedures of the network. If the destination is available and not busy, the caller is connected with the destination and the task 100 can be terminated (129). If the call cannot be connected, a determination is made whether the destination subscriber has a voice mail box (130), and if so the caller is identified by using CLI (“Caller Line Identification”) or any other means (132). Otherwise, an announcement is made (134), and the task 100 is terminated (129). If an old message from the same caller exists (140), an announcement is made (142), and the caller is given an option to access it (150). The originator caller has the option to listen to the old message (142). Otherwise, the caller can record a new message (154). In case the originator caller cannot be identified, he is treated as if no old message exists, an announcement is made (144), and the caller can record a new message (154). Once a message exists (old or new) the caller can accept it (160), or continue to manipulate it (162). After the originator accepts the message the task 100 is ended (169).

The invention embodiment illustrated in FIG. 1 is an improvement over the prior art for various reasons. Primarily, the prior art requires a unique message identifier that is either assigned in advance to each message by the VM system or selected by the caller to enable future access. This makes it possible in the prior art that a message identifier selected by the caller is occupied by another. The present invention employs a means like “Caller ID” (132) to identify the message to eliminate this issue.

Additionally in the prior art, when a caller enters the VM system he must instruct the VM system about his desire to locate an old stored message possibly prior to his knowledge about the status of the old message. Conversely, the present invention directs the VM system 100 to automatically recognize the caller by his Caller ID (132), and subsequently, if an old message from the same caller to the same destination exists and then the system will automatically inform the caller (142), and upon his request (150), direct him in accessing it (160).

Further, the prior art message identifier is system wide. Therefore any caller, by using an existing message identifier (mistakenly or intentionally), can access any previously stored message, even if the old message doesn't belong to him. To the contrary, the present invention is different because only the original caller can access the previously stored message (150) that is achieved automatically using the Caller ID (132).

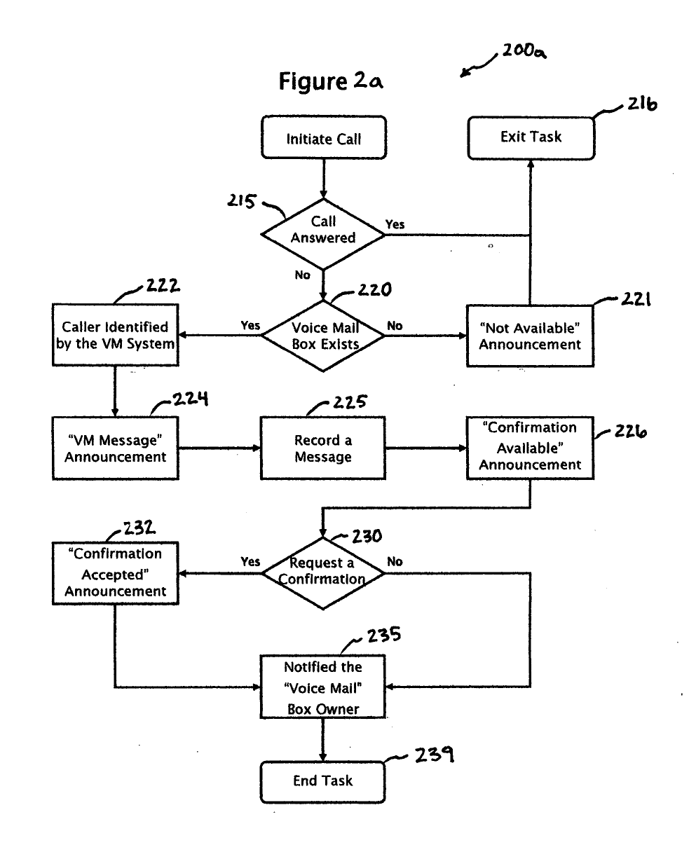

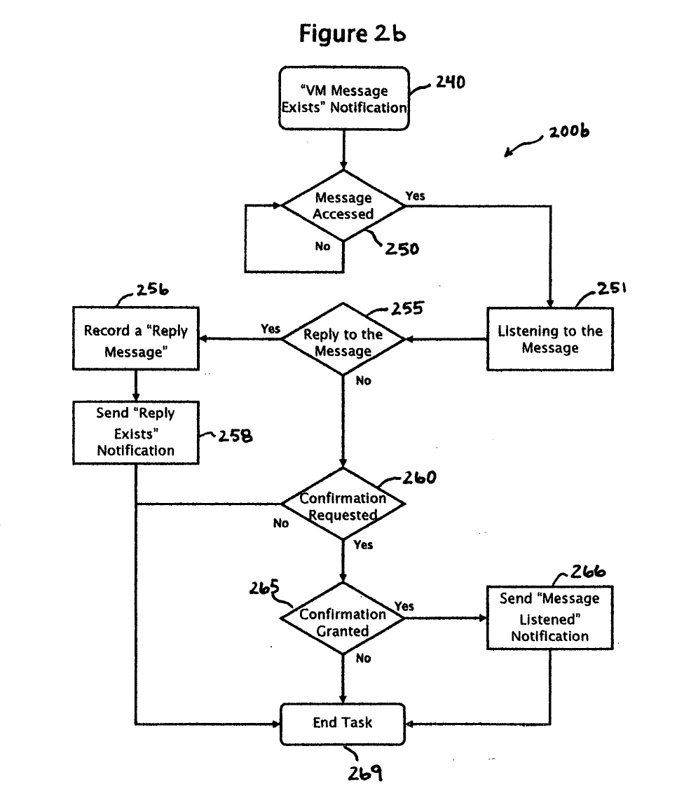

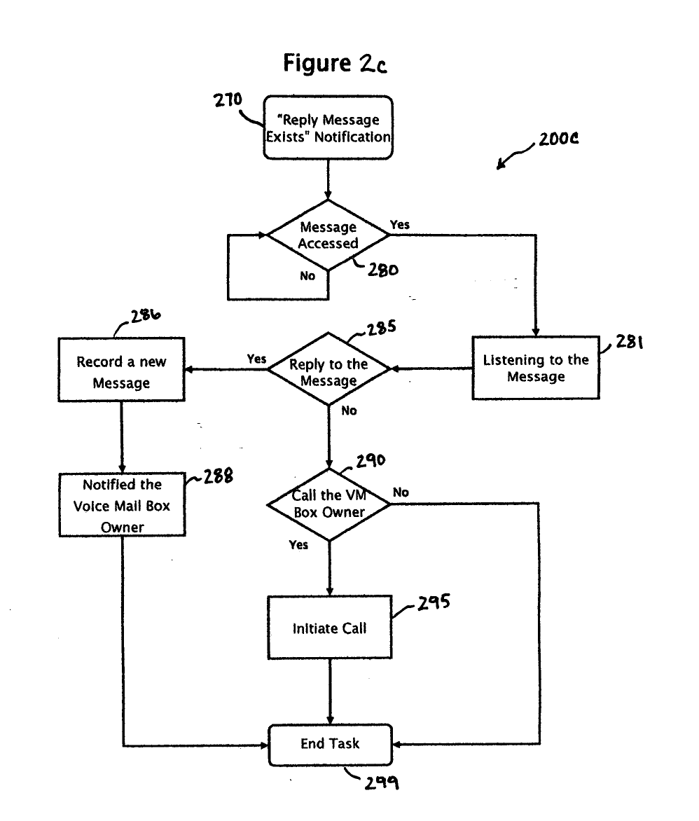

Referring to FIGS. 2a to 2c flowcharts are illustrated showing preferred methods of implementing tasks 200a-c which allow voice mail users to gain greater effectiveness and user friendlier interaction from a voice mail system. These methods may be implemented as add-on functionalities to already existing and well known voice mail systems.

FIG. 2a is the flowchart of a method for recording a message according to the present invention, generally designated 200a. Initially, after a call is initiated (210) a determination is made whether the destination call recipient is reachable (215). In other words, the task 200a tries to connect the call according to normal operating procedures of the network. If the destination is available and not busy (215), the call originator is connected with the destination call recipient and the task 200a can be terminated (216). If the call cannot be connected, a determination is made whether the destination subscriber has an available voice mail box (220) and if so, the caller is identified by using CLI (Caller Line Identification) or any other suitable means (222). An announcement is made (224) and the caller can record a new message (225). Otherwise, an announcement is made (221) for the “Not Available” voice mail box (220), and the task 200a is terminated (216). A “Confirmation Available” announcement is made (226) and the caller is given an option to be notified (230). If he chooses to do so, an announcement is made (232) and notification is sent to the voice mail box owner (235) and the task 200a is ended (239). Otherwise, a notification is sent to the Voice Mail Box owner (step 12) and the task 200a is ended (239).

FIG. 2b is the flowchart of a method for responding to the recorded message, generally designated 200b. Initially, the call recipient having a voice mail box is notified (240). If he chooses to listen to the recorded message (250) he can do so (251). Then the call recipient is given an option to reply (255) and if he chooses to do so, he can record a “Reply Message” (256). The reply message (256) can alternatively be one of a plurality of previously recorded messages. Subsequently, a “Reply Exists” notification is sent to the original caller (258) and the task 200b is ended (269). Otherwise, if a confirmation is requested from the call originator (260) and the call recipient accepts it (265), a notification is sent to the original caller (266) and the task 200b is ended (269). Otherwise, the task 200b is ended (269). The original caller is notified (266) by MMS, SMS or and other suitable means.

FIG. 2c is the flowchart illustrating a method for responding to the reply notification, generally designated 200c. Initially, the call originator is notified that a reply message is waiting (270). If he chooses to listen to the reply message (280) he can do so (281). Then the call originator is given an option to reply again (286) and if he chooses to do so, he can record a new message (286). Next, a notification is sent to the recipient voice mail box owner (288) and the task 200c is ended (299). Otherwise, an option is available to the call originator (290) to call directly to the call recipient (295), and/or the task 200c is ended (299).

Many alterations and modifications may be made by those having ordinary skill in the art without departing from the spirit and scope of the invention. Therefore, it must be understood that the illustrated embodiments have been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed in above even when not initially claimed in such combinations.

While the particular System and Methods for Handling Voice Mail Messages to Increase Voice Traffic in A Telephone System as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

What is claimed is:

1. A method for enabling a caller to access a previously stored message on a destination voice mail box, the method comprising:
initiating a telephonic call to a recipient having the destination voice mail box, the call initiated by a originator wherein the recipient is unavailable to answer the call;
transferring the call to a voice mail box;
determining the telephone number of the originator;
determining if the voice mail box contains a previously recorded message from the originator based on the telephone number;
notifying the originator if the voice mail box contains the previously recorded message; and
providing options to the originator to modify the previously recorded message.

2. The method of claim 1, further comprising:
operating the voice mail system in an ordinary fashion if the voice mail box determines that a previously recorded message does not exist based on the telephone number.

3. The method of claim 1, wherein the providing options to the originator to modify the previously recorded message comprises deleting the message and re-recording the message.

4. The method of claim 1, wherein the determining the telephone number of the originator comprises a caller line identification (CLI) method.

5. The method of claim 1, wherein the previously recorded message has yet to be accessed by the recipient.

6. A method to increase voice traffic on a in a telephone system, the method comprising:
initiating a telephonic call to a recipient having the destination voice mail box, the call initiated by an originator wherein the recipient is unavailable to answer the call;
transferring the call to a voice mail box and providing an option to leave a recorded message;
determining the telephone number of the originator;
providing the originator an option to be notified by the voice mail box when the recorded message has been accessed by the recipient;
notifying the recipient as to the existence of the recorded message; and
providing the recipient an option to record a reply message to the recorded message.

7. The method of claim 6, wherein the notifying the recipient as to the existence of the recorded message is accomplished by Multimedia Messaging Service (MMS) means.

8. The method of claim 6, wherein the notifying the recipient as to the existence of the recorded message is accomplished by Short Message Service (SMS) means.

9. The method of claim 6, further comprising:
notifying the originator in the event that the recipient has recorded a reply message.

10. The method of claim 9, further comprising:
notifying the recipient in the event that originator requested to be notified when the recorded message had been heard by the recipient;
requesting consent from the recipient to notify the originator the recorded message had been heard by the recipient; and
notifying the originator in the event that the recipient consented to notification.

11. The method of claim 9, further comprising:
allowing the recipient the option to select from a plurality of previously prepared messages.

12. The method of claim 9, further comprising:
allowing the originator to call the voice mail box of the recipient to listen to the reply message;
providing an option for the originator to record a new reply message; and
providing an option that the voice mail box attempt to connect the originator to the recipient.

13. A system for increasing voice traffic in a telephone system comprising:
a telephonic call originator;
a telephonic call recipient;
a recipient voice mail box;
a means for identifying a telephone number for the call recipient;
a recorded message supplied by the originator,
an announcement from the voice mail box to the originator that a conformation is available if desired by the originator;
an announcement from the voice mail box to the recipient that the recorded message exists;
an announcement from the voice mail box to the originator that the messages have been listened to by the recipient if the confirmation is desired and if the confirmation is consented to by the recipient; and
a reply message from the recipient to the originator stored in the recipient voice mail box.

14. The system of claim 13, further comprising:
an announcement from the voice mail box to the originator that the reply message exists in the voice mail box.

15. The system of claim 14, further comprising:
a new recorded message from the originator to the voice mail box if the originator elects to record the new message upon receiving the announcement the reply message exists in the voice mail box.

16. The system of claim 14, further comprising:
a renewed telephonic call transmission from the originator to the recipient via the voice mail box, without the need of redialing in the event that the originator elects to do so upon hearing the reply message.
